(19) United States
(12) Patent Application Publication
(10) Pub. No.: US 2008/0289664 A1
(43) Pub. Date: Nov. 27, 2008

(54) Modular drip pan and component mounting assembly for a dishwasher

(76) Inventors: Anthony L. Rockwell, Pickerington, OH (US); Phil Johnson, Louisville, KY (US); Clint Frysinger, Johnstown, OH (US); Albert W. Chan, Howell, MI (US)

Correspondence Address: OWENS CORNING, 2790 COLUMBUS ROAD, GRANVILLE, OH, 43023, US

(21) Appl. No.: 12/119,878

(22) Filed: May 13, 2008

Related U.S. Application Data
(60) Provisional application No. 60/931,658, filed on May 24, 2007.

(51) Int. Cl. B08B 7/00; A47L 15/42

(52) U.S. Cl. 134/42; 134/58 D; 134/57 D

(57) ABSTRACT

A dishwasher for receiving and cleansing soiled kitchenware includes a tub defining a washing chamber, a movable door for selectively exposing the washing chamber, and a modular, slidably mounted drip pan and component mounting assembly or base member positioned below the tub. One or more of a plurality of wash system components, including a wash pump, an inlet valve and a drain valve, is mounted to the modular base member. The modular base member includes connection points for household utilities, a peripheral lip or rim so as to contain any liquid that may fall from the dishwasher tub and a float and cut-off system that serves to terminate operation of the dishwasher upon detecting a water leak. In addition, the modular base member may also contain a system for heating washing fluid to a desired temperature, along with related control components.

### BACKGROUND OF THE INVENTION

1. Field of the Invention

The present invention pertains to the art of dishwashers and, more particularly, to a modular base member that serves as a drip pan, a mounting platform for mechanical components of the dishwasher and a utilities attachment point.

2. Discussion of the Prior Art

A typical dishwasher includes a tub having a front opening that leads to an to interior washing compartment. A door pivotally mounts, in a sealable manner, across the front opening. Mechanical components, such as circulation pumps, drain pumps, heating units, utility connections and the like, are mounted to various portions of the dishwasher. Typically the mechanical components are mounted to bottom and side portions of the tub. In addition, particularly in connection with European-style units, a manufacturer will locate a drip pan below the tub. The drip pan catches any water and/or condensation that may leak or drip from the mechanical components or the tub.

In connection with the present invention, a need has been recognized for a modular base member for a dishwasher having mounted thereto one or more mechanical components necessary for performing a washing operation. The modular base would also serve as a utilities connection point and a drip pan to collect any stray water or condensation.

### SUMMARY OF THE INVENTION

The present invention is directed to a dishwasher for receiving and cleansing soiled kitchenware. The dishwasher includes a tub having bottom, opposing side, rear and top walls which collectively define a washing chamber. A door is mounted for movement relative to the tub for selectively exposing the washing chamber to enable the loading and unloading of the kitchenware. The dishwasher also includes a modular, slidably mounted drip pan and component mounting assembly or base member positioned below the tub.

In accordance with the invention, at least one of a plurality of wash system components, including a wash pump, an inlet valve and a drain valve, is mounted to the modular base member. Preferably, many of the wash system components are mounted to the modular base member. In addition, the modular base member includes connection points for household utilities, such as a hot water hook-up and an electrical hook-up. With this construction, the present invention enables components of the dishwasher to be easily manufactured in one or more locations and shipped to one or more central locations for final integration and delivery to consumers. In addition, a service technician need simply slide the modular base member out from the dishwasher to service any of the plurality of wash system components.

The modular base member also includes a peripheral lip or rim so as to contain any liquid that may fall from the dishwasher tub. Preferably, a float and cut-off system is provided in the modular base member that serves to terminate operation of the dishwasher upon detecting a water leak. In addition, the modular base member may also contain a system for heating washing fluid to a desired temperature, along with related control components.

Additional objects, features and advantages of the present invention will become more readily apparent from the following detailed description of a preferred embodiment when taken in conjunction with the drawings wherein like reference numerals refer to corresponding parts in the several views.

### BRIEF DESCRIPTION OF THE DRAWINGS

FIG. 1 is a perspective view of a dishwasher including a modular drip pan and component mounting assembly constructed in accordance with the present invention;

FIG. 2 is an uppers right perspective view of the dishwasher of FIG. 1 shown without a door and removed from adjacent kitchen cabinetry to illustrate the modular drip pan and component mounting assembly in an extended position;

FIG. 3 is a top view of the dishwasher of FIG. 2; and

FIG. 4 is a partial side elevational view of the dishwasher of FIG. 2.

### DETAILED DESCRIPTION OF THE PREFERRED EMBODIMENT

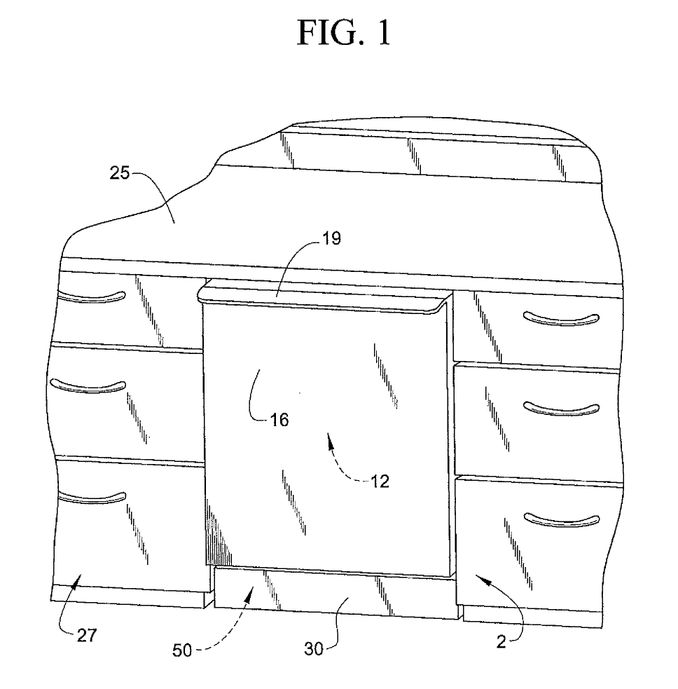

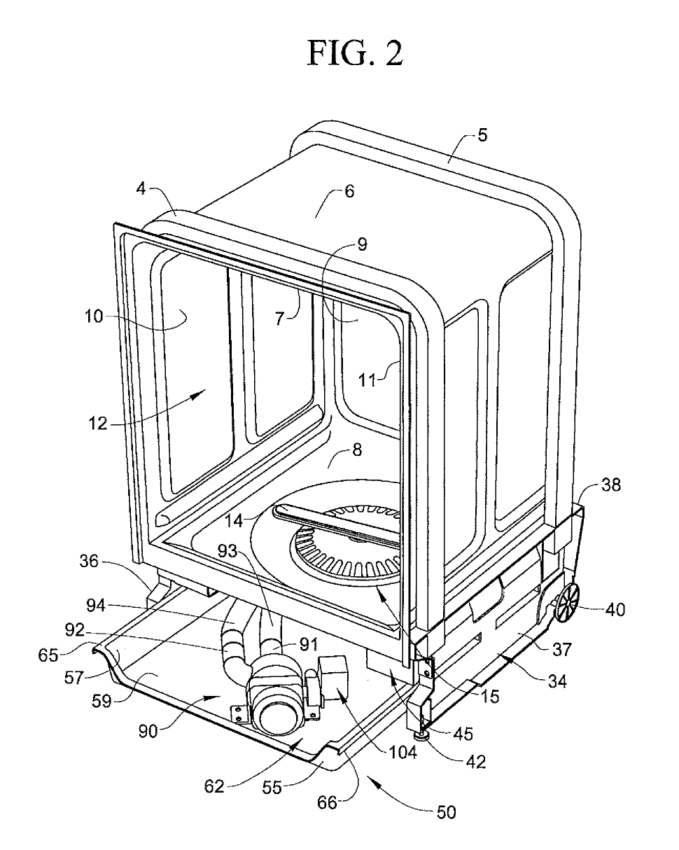

With initial reference to FIGS. 1 and 2, a dishwasher constructed in accordance with the present invention is generally indicated at 2. Dishwasher 2 is shown to include frame members 4 and 5 that support a tub 6 having a top wall 7, a bottom wall 8, a rear wall 9 and opposing side walls 10 and 11 that collectively define a washing chamber 12. As shown, a wash arm 14 is arranged within washing chamber 12 above a sump 15. Wash arm 14 selectively delivers jets of washing fluid onto kitchenware placed within dishwasher 2 in a manner known in the art. Dishwasher 2 is further shown to include a door 16 having a handle 19 that selectively provides access to washing chamber 12. Door 16 further includes a plurality of control elements (not shown) for selecting particular operating parameters of a washing operation. In the embodiment shown, dishwasher 2 is arranged below a countertop 25 adjacent to cabinetry 27 and is provided with a toe kick 30 that extends below door 7 to provide a finished, aesthetic appearance.

As best shown in FIG. 2, dishwasher 2 includes a base portion 34 having first and second opposing side walls 36 and 37 interconnected by a rear wall 38. Base portion 34 is provided with a pair of rear wheels, one of which is indicated at 40, that enable an installer to easily position dishwasher 2 below countertop 25, and a pair of leveling legs, one of which is shown at 42, that enable the installer to accurately position dishwasher 2. In the embodiment shown, a dishwasher controller 45 is mounted to a front portion (not separately labeled) of base portion 34. Dishwasher controller 45 receives input from the control elements (not shown) to establish and selectively control the washing operation. Base portion 34 also preferably houses a modular drip pan and component mounting assembly or base member 50 as will be discussed more fully below.

As best shown in FIGS. 2-4, base member 50 includes front, rear and opposing side walls 55-58 and a bottom wall 59 that collectively define a basin 62. Base member 50 further includes a pair of side rails 65 and 66 that extend along upper edge portions of opposing side walls 57 and 58 respectively. Side rails 65 and 66 slidingly support base member 50 along a pair of glide members, one of which is indicated at 70, provided on first and second opposing side walls 36 and 37 of base portion 34. When base member 50 is in a recessed or retracted position, basin 62 serves as a drip pan collecting any water and/or condensation which may escape dishwasher 2.

In accordance with the invention, base member 50 further serves as a component mounting platform for supporting and providing easy access to various wash system components of dishwasher 2. In the embodiment shown, base member 50 supports a wash pump 90 having an inlet 91 and an outlet 92 that are connected, via corresponding hoses 93 and 94, to sump 15. In operation, wash pump 90 creates a circulating flow of washing fluid within washing chamber 12 during an overall washing operation. In addition, base member 50 supports a drain valve 99 that connects to a main household drain (not shown) through a drain hose (not shown). Base member 50 further supports an inlet valve 104 connected to wash pump 90. Inlet valve 104 receives a supply of water from, for example, a household hot water line (not shown).

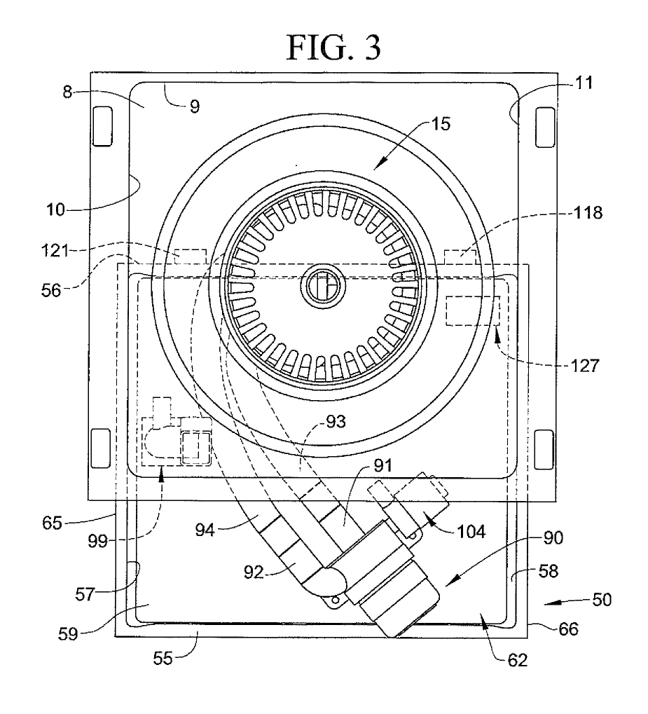

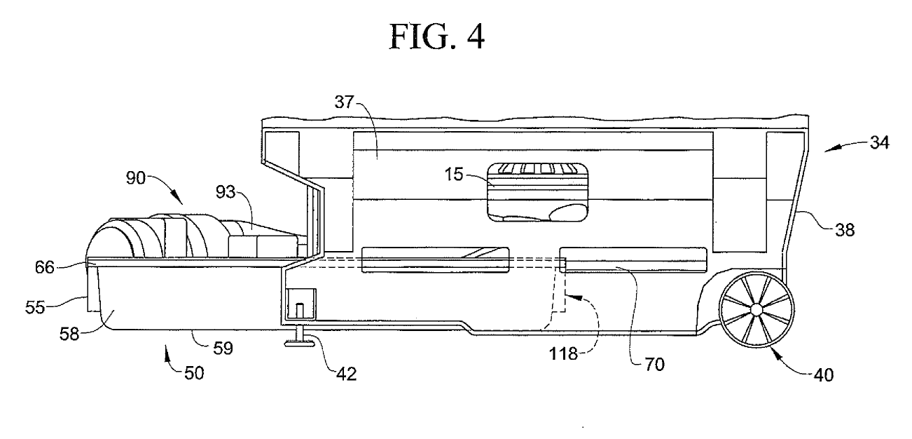

In accordance with one aspect of the invention, base member 50 further includes a pair of connection modules that serve as attachment points for household utilities. More specifically, base member 50 includes a water connection module or hook-up 118 (see FIGS. 3 and 4) and an electrical connection module or hook-up 121 (FIG. 3). Water connection module 118 and electrical connection module 121 are shown mounted to an outer surface of rear wall 56. Although not shown, it should be readily understood that base member 50 could also support a drain connection module for interconnecting drain valve 99 with a household drain.

Finally, base member 50 is shown to include a float valve assembly 127 provided on bottom wall 59. Float valve assembly 127 is operatively connected to controller 45 and, upon sensing water in basin 62, halts operation of dishwasher 2 to prevent the introduction of any additional water and opens drain valve 99 to immediately drain washing chamber 12. Therefore, in the event that dishwasher 2 experiences a leak, float valve assembly 127 effectively shuts down the washing operation to prevent or at least minimize any damage which may occur.

Based on the above, it should be readily understood that the present invention represents an easily manufactured, slidably mounted base or tray member 50 that supports various wash system components of dishwasher 2. Base member 50 can be manufactured in various locations and transported to a central location for incorporation into an overall dishwasher assembly. In addition, by providing the wash system components on base member 50, service personnel can readily access and diagnose any component failures without requiring that the entire dishwasher be dismounted. In addition, by locating the wash system components in a single location, noise attenuation techniques may be employed to limit any noise emanating from dishwasher 2. That is, base member 50 can be supported on acoustic dampening material, such as VERSAMAT® made by Owens Corning, to prevent any vibrations generated by the wash system components from translating to other parts of the dishwasher. In this manner, low frequency noise emanating from wash pump 90 is reduced to nominal levels. Finally, the wash system components can be arranged in such a way so as to allow the overall size of washing chamber 12 to be increased. More specifically, the present invention enables the use of various sump configurations, such as a side sump, enabling the height of the washing chamber to be increased without changing the overall footprint of dishwasher 2.

Although described with reference to a preferred embodiment of the invention, it should be readily understood that various changes and/or modifications can be made to the invention without departing from the spirit thereof. For instance, in addition to the wash components described, base member 50 can support a heater, as well as various other required mechanical and electrical components. The controller can also be mounted to or integrated with the base member to reduce wiring lengths required for the dishwasher.

1. A dishwasher for receiving and cleansing soiled kitchenware comprising:
a washing chamber;
a door mounted for movement relative to the tub for selectively exposing the washing chamber; and
a modular base member shiftably mounted relative to and below the tub, said modular base member supporting at least one of a wash pump, a drain valve, an inlet water connection point and an electrical connection point.

2. The dishwasher according to claim 1, wherein each of a wash pump, a drain valve and an inlet water connection point are attached to the modular base member.

3. The dishwasher according to claim 1, wherein the modular base member supports each of an inlet water connection point and an electrical connection point.

4. The dishwasher according to claim 1, wherein the modular base member includes front, rear, opposing side and bottom walls that collectively define a basin.

5. The dishwasher according to claim 4, further comprising: a float valve positioned in the basin, said float valve being adapted to cut-off operation of the dishwasher upon detecting a predetermined amount of water in the basin.

6. The dishwasher according to claim 4, further comprising: a base portion positioned below the washing chamber, said base member includes first and second opposing side walls and a rear wall, said modular base member being shiftably supported by the base portion.

7. The dishwasher according to claim 6, wherein each of the first and second opposing side walls of the base portion is provided with a glide member.

8. The dishwasher according to claim 7, wherein each of the first and second opposing side walls of the modular base member is provided with a corresponding side rail, each said side rail being supported for relative sliding movement along a respective glide member.

9. The dishwasher according to claim 1, further comprising: a controller mounted adjacent the modular base member.

10. A method of accessing a washing component of a dishwasher comprising:
shifting a modular base member relative to a tub supported by a base portion of the dishwasher; and
directly accessing at least one of a wash pump, a drain valve, an inlet water connection point and an electrical connection point supported by the modular base member.

11. The method of claim 10, further comprising: sliding the modular base member from below the tub, with the modular base member being supported on glide members of the base portion, to access the washing component.

12. The method of claim 10, further comprising:
detecting when a predetermined amount of water is in a basin defined by the modular base member; and
cutting-off operation of the dishwasher when the predetermined amount of water is detected in the basin.

13. The method of claim 12, wherein the predetermined amount of water is detected and operation of the dishwasher is cut-off by a float valve positioned in the basin.

14. The method of claim 14, wherein shifting the modular base member relative to the tub is performed by shiftably supporting side members of the modular base member on respective glide members of the base portion.
